(19) United States
(12) Patent Application Publication
(10) Pub. No.: US 2024/0223373 A1
(43) Pub. Date: Jul. 4, 2024

(54) BLOCKCHAIN-BASED AUTOGRAPHING IN ASSOCIATION WITH PHYSICAL MEMORABILIA

(71) Applicant: Grafting Corp., Redwood City, CA (US)

(72) Inventors: Kellen Kiilsgaard, Redwood City, CA (US); Max Bergen, Redwood City, CA (US); Michael Thomas, Redwood City, CA (US)

(21) Appl. No.: 18/446,356

(22) Filed: Aug. 8, 2023

Related U.S. Application Data
(60) Provisional application No. 63/396,149, filed on Aug. 8, 2022.

(51) Int. Cl. H04L 9/32; G06K 19/07; H04L 9/00

(52) U.S. Cl. CPC H04L 9/3213; G06K 19/0723; H04L 9/3297; H04L 9/50

(57) ABSTRACT

A method of associating an authenticated autograph with physical memorabilia based on a blockchain is disclosed. The method includes recording a video that captures an identifiable person making a distinctive mark to be associated with a physical memorabilia, causing the video to be cryptographically stored in the blockchain via a non-fungible token (NFT), causing generation of a reference tag that encodes access to the NFT, and causing physical affixing of the reference tag with the physical memorabilia.

### TECHNICAL FIELD

The present disclosure relates generally to a Blockchain technology, and more particularly, but not exclusively, to a system and method for Blockchain-based autographing in association with physical memorabilia.

### BACKGROUND

Blockchain technology, also known as distributed ledger technology, is an emerging technology in which several computing devices participate in “bookkeeping” and jointly maintain a complete distributed database. A blockchain ledger can maintain a permanent, indelible, and unalterable history of transactions. Because blockchain technology is characterized by being decentralized, open and transparent, enabling each computing device to participate in database recording in an “immutable” manner, and enabling data synchronization to be performed quickly between the computing devices, blockchain technology is widely used in many fields.

### BRIEF SUMMARY

The present disclosure is directed towards a method for associating an authenticated autograph with physical memorabilia based on a blockchain. The method includes recording a video that captures an identifiable person making a distinctive mark to be associated with a physical memorabilia, causing the video to be cryptographically stored in the blockchain via a non-fungible token (NFT), causing generation of a reference tag that encodes access to the NFT, and causing physical affixing of the reference tag with the physical memorabilia.

In some embodiments of the method for associating an blockchain-based authenticated autograph with physical memorabilia, the distinctive mark is a signature of the identifiable person. In another aspect of some embodiments, the video captures the identifiable person creating the signature in contact with the physical memorabilia. In still another aspect of some embodiments, the video is cryptographically stored in the blockchain with a timestamp evidencing a temporal proximity to a conclusion of the recording. In yet another aspect of some embodiments, the NFT is created with a timestamp evidencing a temporal proximity to a conclusion of the recording.

In a further aspect of some embodiments, a reference to the video by the NFT is generated with a timestamp evidencing a temporal proximity to a conclusion of the recording. In an additional aspect of some embodiments, the reference tag includes at least one of a quick response (QR) code or a radio-frequency identification (RFID) tag. In still another aspect of some embodiments, the causing of the video to be cryptographically stored in the blockchain via the non-fungible token (NFT) occurs in real-time with a conclusion of the recording of the video. In yet another aspect, some embodiments of the method further comprise: linking the NFT with the physical memorabilia such that the NFT cannot be transferred without the physical memorabilia and the physical memorabilia cannot be transferred without the NFT.

In other embodiments, one or more methods for associating an authenticated transformative event having a tangible result with a physical object based on a blockchain are disclosed. The method includes: recording visual content that captures the transformative event having the tangible result to be associated with the physical object, causing the visual content to be cryptographically stored in the blockchain via a non-fungible token (NFT), causing generation of a reference tag that encodes access to the NFT, and causing physical affixing of the reference tag with the physical object.

In some embodiments of the method for associating an blockchain-based authenticated autograph with physical memorabilia, a distinctive mark is a signature of an identifiable person. In another aspect of some embodiments, a video captures the identifiable person creating the signature in contact with a physical memorabilia. In still another aspect of some embodiments, a video is cryptographically stored in the blockchain with a timestamp evidencing a temporal proximity to a conclusion of the recording. In yet another aspect of some embodiments, the NFT is created with a timestamp evidencing a temporal proximity to a conclusion of the recording.

In a further aspect of some embodiments, a reference to a video by the NFT is generated with a timestamp evidencing a temporal proximity to a conclusion of the recording. In an additional aspect of some embodiments, the reference tag includes at least one of a quick response (QR) code or radio-frequency identification (RFID) tag. In still another aspect of some embodiments, the causing of the visual content to be cryptographically stored in the blockchain via the non-fungible token (NFT) occurs in real time or near a conclusion of a capture of the visual content. In yet another aspect of some embodiments, a captured video content of the transformative event having the tangible result includes one or more of a photo, a series of photos, another type of sensor image, and a series of sensor images from another type of sensor. In another aspect, some embodiments of the method further comprise: linking the NFT with the physical object such that the NFT cannot be transferred without the physical object and the physical object cannot be transferred without the NFT.

In other embodiments, a system for associating an authenticated autograph with a physical memorabilia based on a blockchain is disclosed. This blockchain-based authenticated autograft system includes a memory that stores computer-executable instructions, and a processor that executes the computer-executable instructions. The execution of the instructions causes the processor to: record a video that captures an identifiable person making a distinctive mark to be associated with the physical memorabilia, cause the video to be cryptographically stored in the blockchain via a non-fungible token (NFT), cause generation of a reference tag that encodes access to the NFT, and cause physical affixing of the reference tag with the physical memorabilia.

In some embodiments of the system for associating an blockchain-based authenticated autograph with physical memorabilia, the distinctive mark is a signature of the identifiable person. In another aspect of some embodiments, the video captures the identifiable person creating the signature in contact with the physical memorabilia. In still another aspect of some embodiments, the video is cryptographically stored in the blockchain with a timestamp evidencing a temporal proximity to a conclusion of the recording. In yet another aspect of some embodiments, the NFT is created with a timestamp evidencing a temporal proximity to a conclusion of the recording.

In a further aspect of some embodiments, a reference to the video by the NFT is generated with a timestamp evidencing a temporal proximity to a conclusion of the recording. In an additional aspect of some embodiments, the reference tag includes at least one of a quick response (QR) code or a radio-frequency identification (RFID) tag. In still another aspect of some embodiments, the causing of the video to be cryptographically stored in the blockchain via the non-fungible token (NFT) occurs in real-time with a conclusion of the recording of the video. In yet another aspect, some embodiments of the system comprise further instructions that when executed causes the processor to: link the NFT with the physical memorabilia such that the NFT cannot be transferred without the physical memorabilia and the physical memorabilia cannot be transferred without the NFT.

In additional embodiments, another system for associating an authenticated transformative event having a tangible result with a physical object based on a blockchain is disclosed. This blockchain-based authenticated autograft system includes a memory that stores computer-executable instructions, and a processor that executes the computer-executable instructions. The execution of the instructions causes the processor to: record visual content that captures the transformative event having the tangible result to be associated with the physical object, cause the visual content to be cryptographically stored in the blockchain via a non-fungible token (NFT), cause generation of a reference tag that encodes access to the NFT, and cause physical affixing of the reference tag with the physical object.

In some embodiments of the system for associating an blockchain-based authenticated autograph with physical memorabilia, the distinctive mark is a signature of the identifiable person. In another aspect of some embodiments, the video captures the identifiable person creating the signature in contact with the physical memorabilia. In still another aspect of some embodiments, the video is cryptographically stored in the blockchain with a timestamp evidencing a temporal proximity to a conclusion of the recording. In yet another aspect of some embodiments, the NFT is created with a timestamp evidencing a temporal proximity to a conclusion of the recording.

In a further aspect of some embodiments, a reference to the video by the NFT is generated with a timestamp evidencing a temporal proximity to a conclusion of the recording. In an additional aspect of some embodiments, the reference tag includes at least one of a quick response (QR) code or a radio-frequency identification (RFID) tag. In still another aspect of some embodiments, the causing of the video to be cryptographically stored in the blockchain via the non-fungible token (NFT) occurs in real-time with a conclusion of the recording of the video. In yet another aspect, some embodiments of the system comprise further instructions that when executed causes the processor to: link the NFT with the physical object such that the NFT cannot be transferred without the physical object and the physical object cannot be transferred without the NFT.

These features with other technological improvements, which will become subsequently apparent, reside in the details of construction and operation as more fully described hereafter and claimed, reference being had to the accompanying drawings forming a part hereof.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates an example implementation of a “Grafting” stage of the blockchain-based authenticated autograft system, in accordance with some embodiments.

FIG. 2 illustrates an example implementation of an “Authenticating” stage of the blockchain-based authenticated autograft system, in accordance with some embodiments.

FIG. 3 illustrates an example implementation of a “Minting” stage of the blockchain-based authenticated autograft system, in accordance with some embodiments.

FIG. 4 illustrates an example implementation of a “Packaging/Tagging” stage of the blockchain-based authenticated autograft system, in accordance with some embodiments.

FIG. 5 illustrates an example implementation of a “Listing” stage of the blockchain-based authenticated autograft system, in accordance with some embodiments.

FIG. 6 illustrates an example implementation of a “Collecting” stage of the blockchain-based authenticated autograft system, in accordance with some embodiments.

FIG. 7 illustrates an example implementation of a “Ledgering” stage of the blockchain-based authenticated autograft system, in accordance with some embodiments.

FIG. 8 is a flow diagram illustrating a process for blockchain-based autographing, in accordance with some embodiments.

FIG. 9 is a diagram illustrating a hardware structure of a device where an apparatus for blockchain-based autographing is located according to some embodiments of the present specification.

FIG. 10 illustrates a system diagram that describes an example implementation of a computing system(s) for blockchain-based autographing as implemented in embodiments described herein.

### DETAILED DESCRIPTION

Persons of ordinary skill in the art will understand that the present disclosure is illustrative only and not in any way limiting. Other embodiments and various combinations of the presently disclosed system and method readily suggest themselves to such skilled persons having the assistance of this disclosure.

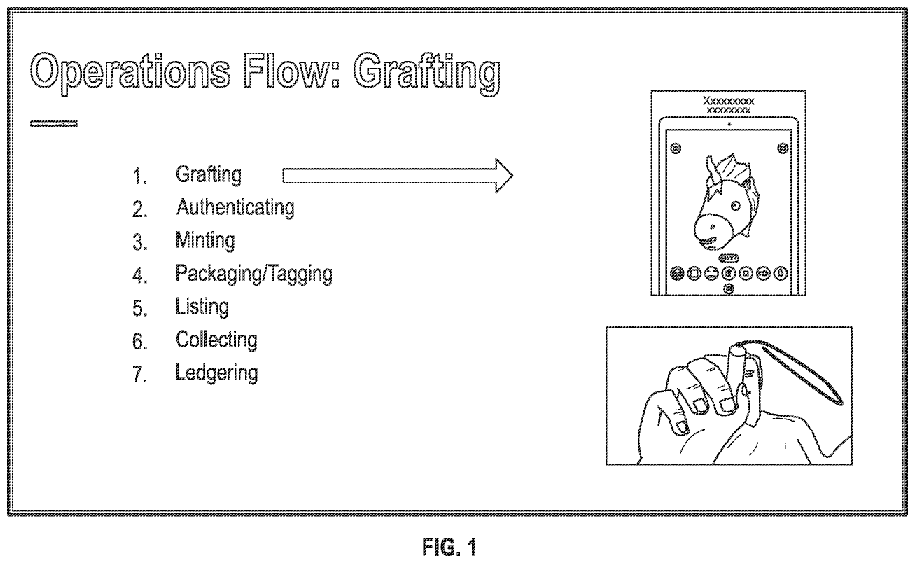

Each of the features and teachings disclosed herein can be utilized separately or in conjunction with other features and teachings to provide a blockchain-based system and method that associates an authenticated autograph with physical memorabilia. Representative examples utilizing many of these additional features and teachings, both separately and in combination, are described in further detail with reference to attached FIGS. 1-10. This detailed description is intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method. Also, other methods and systems may be used.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof.” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The disclosed blockchain-based system and method for associating an authenticated autograph with physical memorabilia addresses the demand for memorabilia attached to athletes, movie stars, singers, or other celebrities, which has existed for decades. However, facilitating, validating, authenticating, or grading such memorabilia have been a challenging and expensive task, often requiring a third party's manual inspection, investigation or other manual involvement.

The presently disclosed blockchain-based authenticated autograft system and method can be described as a “Hybrid NFT Collectible.” The auto-graft collectible constitutes a new (non-fungible token) NFT authenticated asset class, which eliminates or minimizes the need for third party manual involvement. In accordance with various embodiments, blockchain-authenticated memorabilia is lower cost, immediate, and undeniably accurate. This pairing of an owner's access to exclusive celebrity content is a far superior option to expensive, slow, and archaic authentication technology services.

A blockchain is typically a growing list of records, called blocks, which are securely linked together using cryptography. Each block can contain a cryptographic hash of the previous block, a timestamp, and transaction data. The timestamp proves that the transaction data existed when the block was published to get into its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks.

Blockchains are typically managed by a peer-to-peer network for use as a publicly distributed ledger, where nodes collectively adhere to a protocol to communicate and validate new blocks. In some embodiments, a blockchain (e.g., a private blockchain) can be implemented by nodes associated with a single entity or a specific set of entities.

An NFT can be stored in a blockchain. The ownership of an NFT is recorded in the blockchain, and can be transferred by the owner, allowing NFTs to be sold, traded, or otherwise transferred. NFTs can contain references to digital files such as photos, videos, and audio. Because NFTs are uniquely identifiable, they differ from cryptocurrencies, which are fungible. The market value of an NFT can be associated with the digital file it references. Technologically, NFTs serve as a form of public certificate of authenticity or proof of ownership.

In the blockchain technology, nodes in the blockchain usually need to rely on a corresponding smart contract to operate blocks. For example, operations such as storage, modification, and deletion in the blockchain need to rely on the smart contract. The smart contract can be a computer protocol that can be deployed in the blockchain to disseminate, verify, or perform a contract in an automated manner. Corresponding operations can be implemented by declaring service logic in the smart contract. The smart contract allows trusted transactions to be conducted without a third party. These transactions are traceable and irreversible. The smart contract can ensure higher levels of security than a conventional contract method and reduce other transaction costs related to the contract. Generally, smart contracts can be deployed locally in blockchain nodes. When a node needs to perform a certain action, the node can invoke the corresponding smart contract and execute the smart contract to perform service logic declared in the smart contract, so as to obtain an execution result.

In some embodiments, the presently disclosed blockchain-based authenticated autograft system includes a method for associating an authenticated autograph with a physical memorabilia based on a blockchain. One such method includes recording a video that captures an identifiable person making a distinctive mark to be associated with a physical memorabilia, and in real-time with the conclusion of the recording, causing the video to be cryptographically stored in a blockchain via an NFT. One such method also includes causing generation of a reference tag that encodes access to the NFT, and causing physical affixing of the reference tag with the physical memorabilia.

In some embodiments, the distinctive mark is a signature of the identifiable person. In some embodiments, the video captures the identifiable person creating the signature in contact with the physical memorabilia. In an aspect of some embodiments, the video is cryptographically stored in the blockchain with a timestamp evidencing a temporal proximity to the conclusion of the recording. In another aspect of some embodiments, the NFT is created with a timestamp evidencing a temporal proximity to the conclusion of the recording. In still another aspect of some embodiments, a reference to the video by the NFT is generated with a timestamp evidencing a temporal proximity to the conclusion of the recording. In yet another aspect of some embodiments, the reference tag includes at least one of a quick response (QR) code or radio-frequency identification (RFID) tag.

The presently disclosed blockchain-based authenticated autograft system provides greater control and leverage over an individuals own brand, image, name recognition, or other extension via automated tools for creating, owning, and transferring unique NFT-authenticated hybrid assets (a.k.a. “AutoGraft” or “Graft”), and autographing memorabilia digital “Moments” (NFTs).

In some embodiments, the presently disclosed blockchain-based authenticated autograft system includes a method for associating an authenticated transformative event having a tangible result with a physical object based on a blockchain, in contrast to an identifiable person making a distinctive mark to be associated with a physical memorabilia. In such embodiments, what may be significant and valuable is the occurrence of an event and the tangible result that a physical object that has a transformative effect of the physical object. In such embodiments, the person present at the event or that records/captures the event may not be as significant to the transformative event. For example, a cover being knocked off a baseball, a basketball hoop being broken off of a basketball backboard, a chunk of concrete being knocked off of the Berlin Wall when it fell, and the like.

In one or more embodiments, the blockchain-based authenticated autograft method includes recording visual content that captures the transformative event having the tangible result that is associated with the physical object, and with the visual capturing of the transformative event and the tangible result, causing the visual capturing of the transformative event and the tangible result to be cryptographically stored in a blockchain via an NFT. On such method also includes causing generation of a reference tag that encodes access to the NFT, and causing physical affixing of the reference tag with the physical object. In some embodiments, (instead of video capture) the visual content capturing of the transformative event is achieved using a photo, series of photos, GIF (Graphics Interchange Format), other sensor image, or series of sensor images.

FIGS. 1-7 illustrate an example implementation of the presently disclosed blockchain-based authenticated autograft system and method, in accordance with some embodiments. As shown in FIG. 1, at the “Grafting” stage of the blockchain-based authenticated autograft system and method, an AutoGraft Creator (e.g., athlete, musician, celebrity, or other individual) records a one-of-one 6-10 second autograph moment (the “Graft”). The video can capture the Creator in a way that identifies the Creator (e.g., the Creator's face), capture the entire process of the Creator autographing, capture the physical memorabilia, capture the Creator's physical contact with the physical memorabilia, or other visual content evidencing an association between the Creator and the physical memorabilia. In other embodiments, the blockchain-based authenticated autograft system and method records a shorter autograph moment. In another embodiment, the blockchain-based authenticated autograft system and method records a longer autograph moment. In still other embodiments, the blockchain-based authenticated autograft system and method is configured to automatically record the autograph moment, for example, by configuring the recording device to be triggered by a motion sensor or a time-based initiation system.

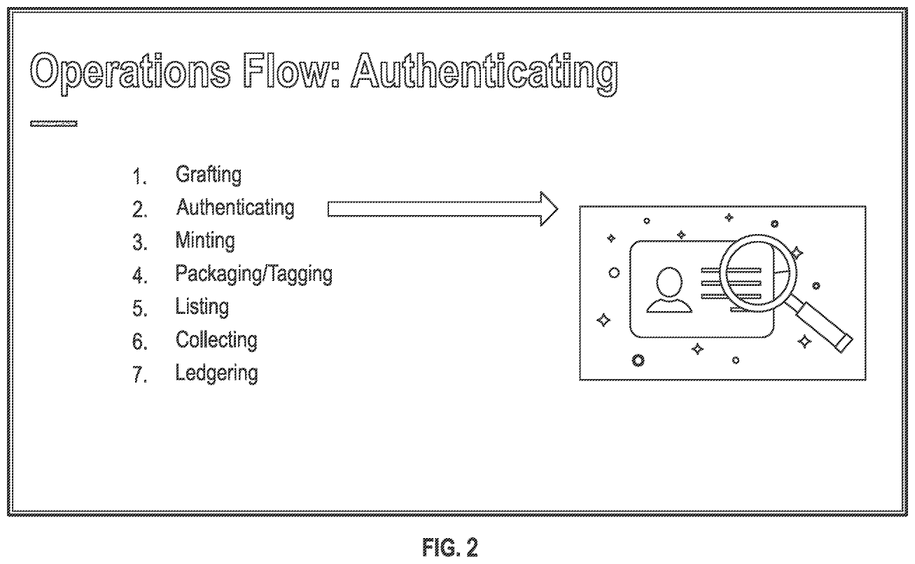

As shown in FIG. 2, at the “Authenticating” stage of the blockchain-based authenticated autograft system and method, the Creator's identity is authenticated, for example, via the identifying features (e.g., face, gait, etc.) captured in the video or other biometrics (e.g., fingerprints via a fingerprint scanner that is either part of the blockchain-based authenticated autograft system or configured to interface with the blockchain-based authenticated autograft system, retina via a retina scanner that is either part of the blockchain-based authenticated autograft system or configured to interface with the blockchain-based authenticated autograft system, etc.). In other embodiments, other sufficiently secure authentication techniques may be employed, such as passwords, cryptographic identification devices, or other identification techniques may be implemented in addition to, or alternatively to, the identifying features captured in the video.

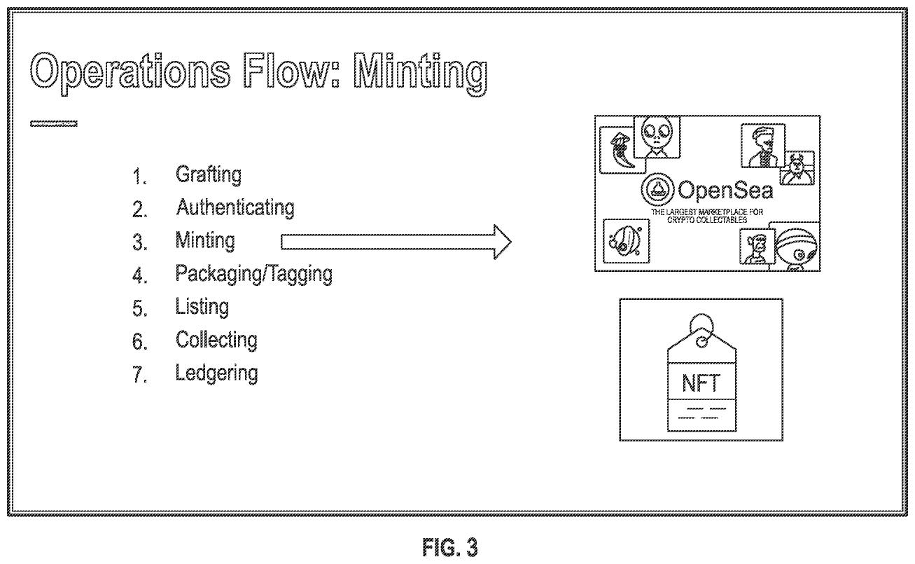

As shown in FIG. 3, at the “Minting” stage of the blockchain-based authenticated autograft system and method, video file (or Graft) is encrypted, and minted as an NFT based on a blockchain. In one such embodiment, the Graft video moment is saved via smart contract only (e.g., not stored locally on the recording device) into an Ethereum blockchain data room. In some embodiments, the NFT contract minting is performed using applicable NFT APIs that interface the recording device with one or more nodes of a blockchain network that implements the Ethereum blockchain.

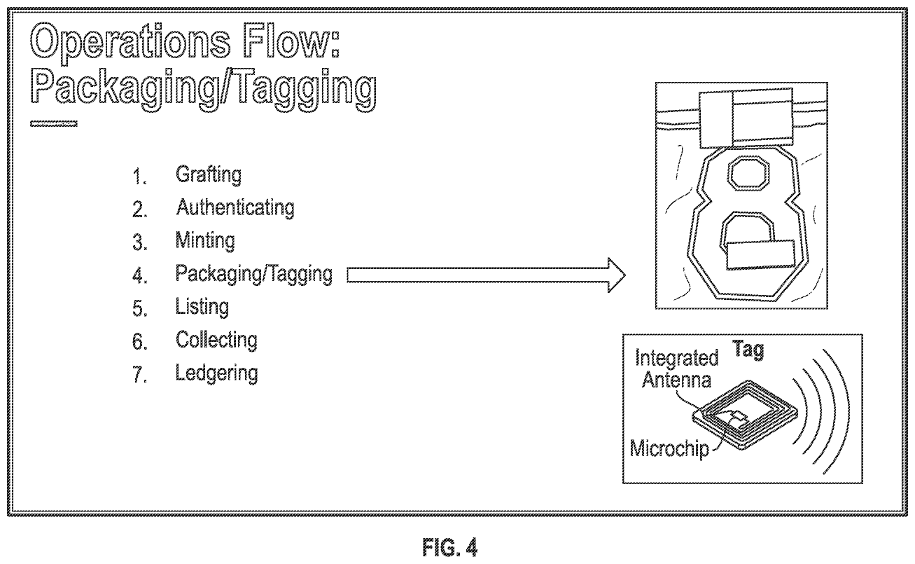

As shown in FIG. 4, at the “Packaging/Tagging” stage of the blockchain-based authenticated autograft system and method, the physical memorabilia (e.g., card, jersey, helmet, or the like) is stamped, branded, riveted, or otherwise affixed with a reference tag that corresponds to the NFT asset (e.g., a quick response (QR) code encoding access to the NFT). This way, each NFT and its matching physical memorabilia (i.e., the NFT asset) are secured by each other: one loses value without the other. In some embodiments, one cannot be transferred without the other.

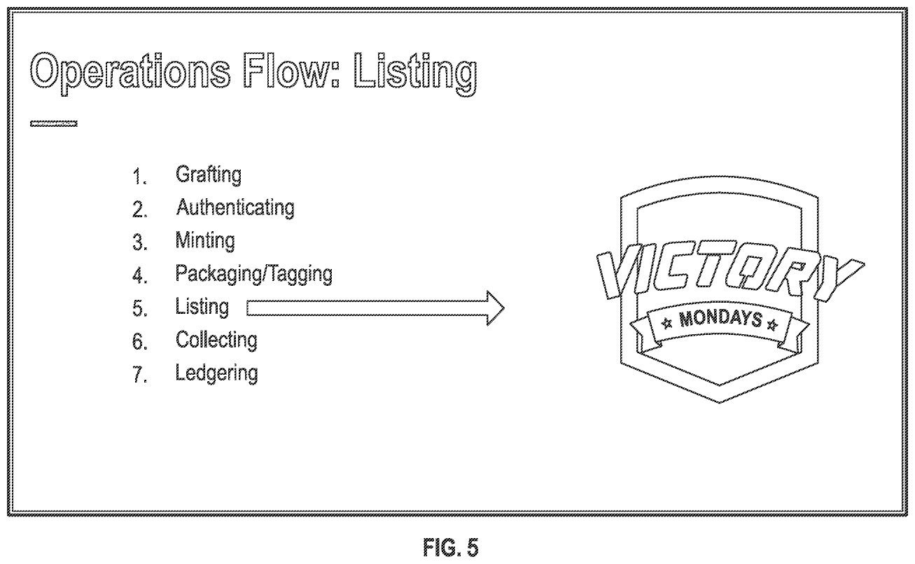

As shown in FIG. 5, at the “Listing” stage of the blockchain-based authenticated autograft system and method, the NET asset can be listed for public or private auction simultaneously on the web and mobile platforms. Notably, this is an optionally stage or operation of the blockchain-based authenticated autograft system and method. The NET asset does not have to be listed for public or private auction in some embodiments of the blockchain-based authenticated autograft system and method. For example, the NET asset created by the blockchain-based authenticated autograft system and method, as well as the physical memorabilia associated with the NFT, may be sold using any of many various transaction technologies. In still other embodiments, the NFT asset created by the blockchain-based authenticated autograft system and method, as well as the physical memorabilia associated with the NFT, are not sold at all. For example, the NFT asset created by the blockchain-based authenticated autograft system and method and the associated physical memorabilia may be held by the original owners or may be gifted to another individual or entity.

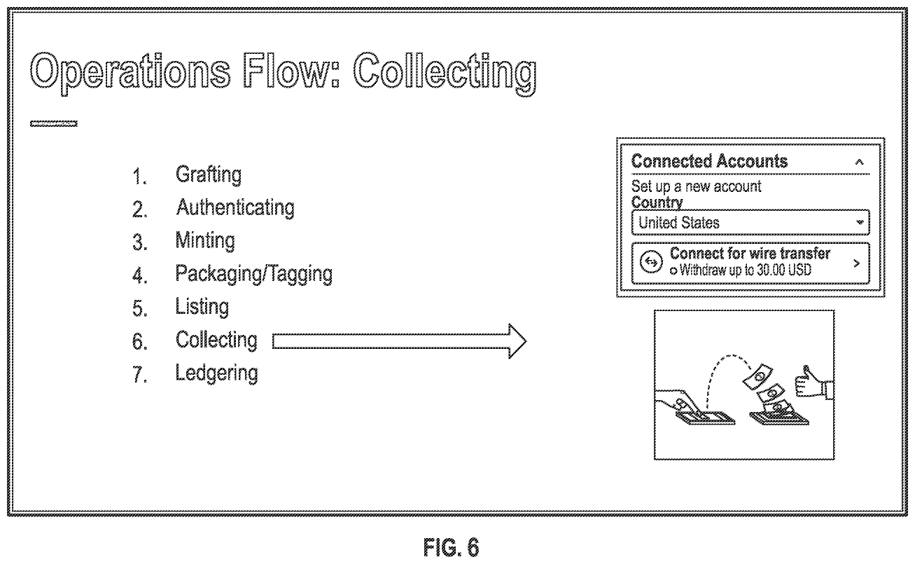

As shown in FIG. 6, at the “Collecting” stage of the blockchain-based authenticated autograft system and method, the NET asset can be bid on or purchased by any user with a smartphone or internet connection, and then further traded or otherwise transferred on a supported secondary blockchain market. Notably, this is an optionally stage or operation of the blockchain-based authenticated autograft system and method. In some embodiments of the blockchain-based authenticated autograft system and method, the NET asset does not have to be bid on or purchased by any user with a smartphone or internet connection. Additionally, the NFT does not have to be further traded or otherwise transferred on a supported secondary blockchain market. For example, the NET asset created by the blockchain-based authenticated autograft system and method, as well as the physical memorabilia associated with the NFT, may be purchased using any of many various transaction technologies. In still other embodiments, the NET asset created by the blockchain-based authenticated autograft system and method, as well as the physical memorabilia associated with the NFT, are not purchased at all. For example, the NET asset created by the blockchain-based authenticated autograft system and method and the associated physical memorabilia may be held by the original owners.

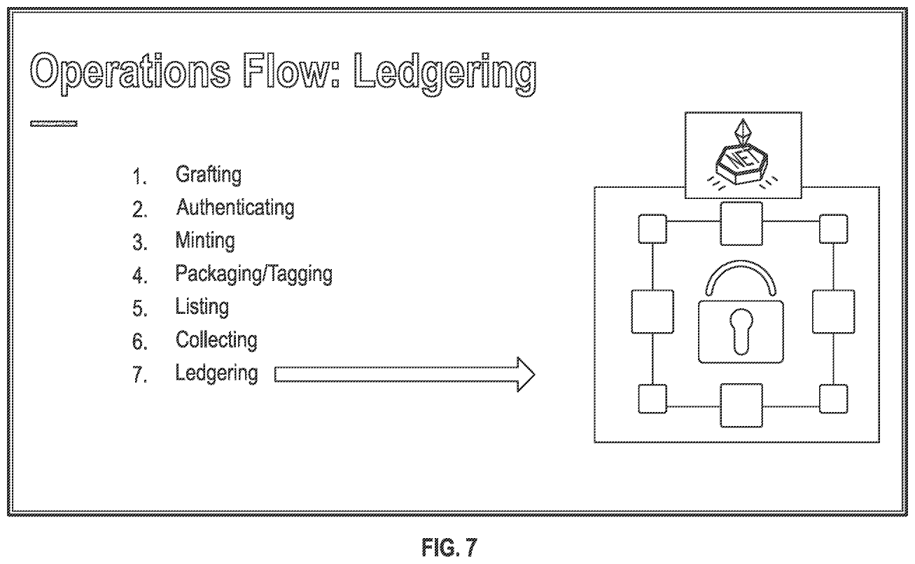

As shown in FIG. 7, at the “Ledgering” stage of the blockchain-based authenticated autograft system and method, the corresponding transaction(s) of the NET asset are recorded via one or more blockchains. Notably, this is an optionally stage or operation of the blockchain-based authenticated autograft system and method. In some embodiments of the blockchain-based authenticated autograft system and method, the NET asset does not have to be recorded via one or more blockchains. For example, the NET asset created by the blockchain-based authenticated autograft system and method, may be recorded using any of many various ledger technologies.

Accordingly, the NFT can be used to validate the actual signed memorabilia in a collector's hands, thus creating a collectible asset that is both “tangible” to the touch and recorded in the blockchain via NFT. The presently disclosed blockchain-based authenticated autograft system and method provides a novel platform for users to create exclusive content over which a collector can have self-verifiable sole-ownership. This exclusive content that is created by the blockchain-based authenticated autograft system and method has the unique feature of having a physical component and a securely linked cryptographic components, unlike a traditional NFT that is merely a virtual token.

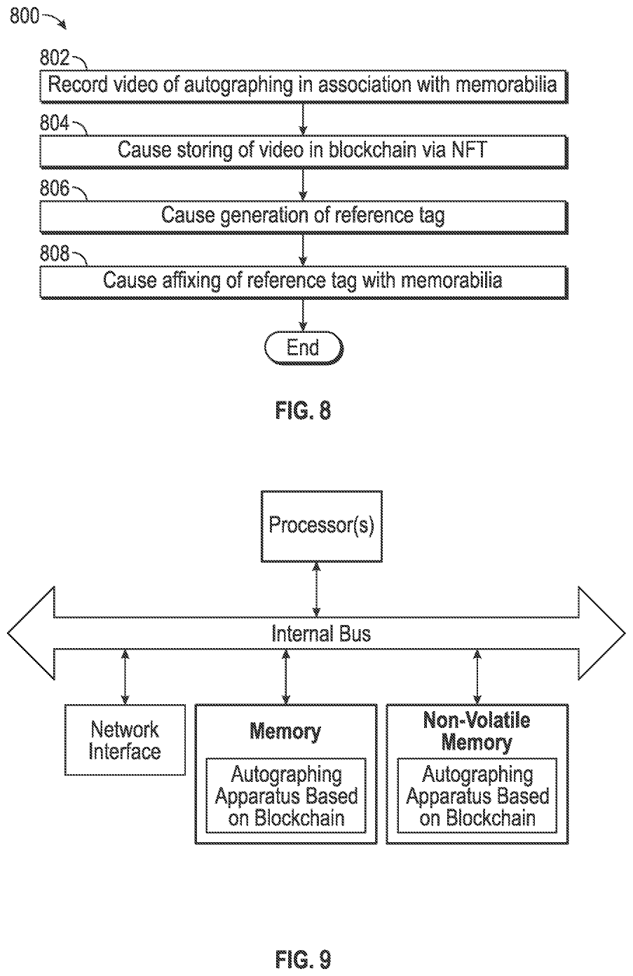

FIG. 8 is a flow diagram illustrating a process 800 for blockchain-based autographing, in accordance with some embodiments. At least part of the blockchain-based authenticated autograft method 800 can be performed by a computing device, such as a personal computer, a laptop computer, a cellular phone, a camera phone, a smartphone, a personal digital assistant, a media player, a navigation device, an email sending and receiving device, a game console, a tablet computer, a wearable device, or a combination thereof. The blockchain-based authenticated autograft method 800 can support or otherwise correspond to the example implementation shown in FIGS. 1-7.

As shown in FIG. 8, at block 802, the blockchain-based authenticated autograft method 800 includes recording a video that captures an identifiable person making a distinctive mark to be associated with a physical memorabilia. For example, a smartphone can be used to shoot an HD video not exceeding a threshold length (e.g., 10 seconds), via a dedicated smartphone app. In some embodiments, the distinctive mark is a signature of the identifiable person. In other embodiments, the video captures the identifiable person creating the signature in contact with the physical memorabilia. In another aspect of some embodiments, at least a threshold length (e.g., 3 seconds), size, or resolution of the video must be a close-up of the signature being created and finished.

At block 804, the blockchain-based authenticated autograft method 800 includes, in real-time with the conclusion of the recording, causing the video to be cryptographically stored in a blockchain via an NFT. In some embodiments, the video file uploads directly to a private server or data warehouse where it is recorded to a blockchain (e.g., using Ethereum blockchain via OpenSea NFT APIs), and the video file is not stored locally on the recording device. In other embodiments, the blockchain-based authenticated autograft method 800 includes causing the video to be cryptographically stored in a blockchain via an NFT within a short amount of time (e.g., seconds, minutes, or hours) but not in real-time. In some embodiments, this short delay may be appropriate due to the technological limitations or configuration of the blockchain-based authenticated autograft system.

In some embodiments, the video is cryptographically stored in the blockchain with a timestamp evidencing a temporal proximity (e.g., within 10 minutes, 1 minute, 10 seconds, 1 second, or the like) to the conclusion of the recording. In some embodiments, the NFT is created with a timestamp evidencing a temporal proximity to the conclusion of the recording. In some embodiments, a reference to the video by the NFT is generated with a timestamp evidencing a temporal proximity to the conclusion of the recording.

At block 806, the blockchain-based authenticated autograft method 800 includes causing generation of a reference tag that encodes access to the NFT. For example, in some embodiments the reference tag includes at least one of a QR code or RFID tag. At block 808, the blockchain-based authenticated autograft method 800 includes causing physical affixing of the reference tag with the physical memorabilia.

Corresponding to the above implementations of the blockchain-based authenticated autograft method 800, the present disclosure further provides implementations of an apparatus for blockchain-based autographing. The apparatus implementations can be achieved by using software, hardware, or a combination thereof. Taking software implementation as an example, a logical apparatus is implemented by reading, using one or more processors of a device where the apparatus is located, corresponding computer service program instructions in a non-volatile memory into a memory for running.

On the hardware level, FIG. 9 is a diagram illustrating a hardware structure of a device where an apparatus for blockchain-based autographing is located according to some embodiments of the present specification. In addition to processor(s), a network interface, a memory, and a non-volatile memory shown, the device where the apparatus according to the implementations is located can generally further include other hardware depending on the actual functions to be performed. Details are omitted for simplicity.

The systems, apparatuses, modules, or units illustrated in the above implementations can be implemented by computer chips or entities, or by products with certain functions. A typical implementation device is a computer. The implementation device can be a personal computer, a laptop computer, a cellular phone, a camera phone, a smartphone, a personal digital assistant, a media player, a navigation device, an email sending and receiving device, a game console, a tablet computer, a wearable device, or a combination thereof.

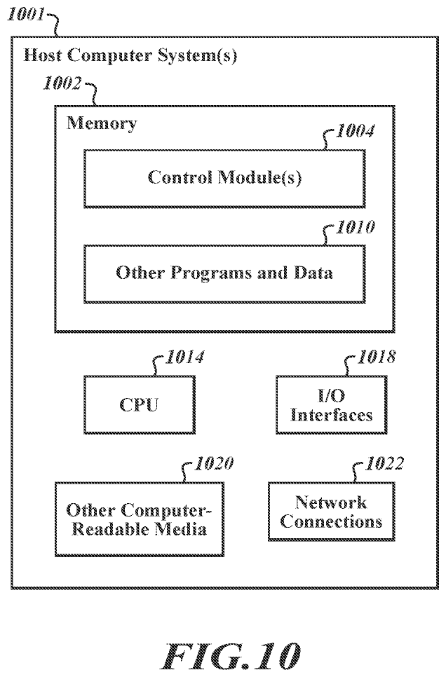

FIG. 10 shows a system diagram that describes an example implementation of a computing system(s) for implementing embodiments described herein. The functionality described herein for a blockchain-based authenticated autograft system and method, can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that it is agnostic to the underlying cloud infrastructure, allowing higher deployment agility and flexibility.

In particular, shown is an example server or host computer system(s) 1001. In some embodiments, one or more special-purpose computing systems may be used to implement the functionality described herein. Accordingly, various embodiments described herein may be implemented in software, hardware, firmware, or in some combination thereof. Host computer system(s) 1001 may include memory 1002, one or more central processing units (CPUs) 1014, I/O interfaces 1018, other computer-readable media 1020, and network connections 1022.

Memory 1002 may include one or more various types of non-volatile and/or volatile storage technologies. Examples of memory 1002 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 1002 may be utilized to store information, including computer-readable instructions that are utilized by CPU 1014 to perform actions, including those of embodiments described herein.

Memory 1002 may have stored thereon control module(s) 1004. The control module(s) 1004 may be configured to implement and/or perform some or all of the functions of the systems, components and modules described herein for a blockchain-based authenticated autograft system and method. Memory 1002 may also store other programs and data 1010, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, etc.

Network connections 1022 are configured to communicate with other computing devices to facilitate the functionality described herein. In various embodiments, the network connections 1022 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1018 may include a video interface, other data input or output interfaces, or the like. Other computer-readable media 1020 may include other types of stationary or removable computer-readable media, such as removable flash drives, external hard drives, or the like.

Some methods, functions, steps, or features have been described as being executed by corresponding software by a processor. It is understood that any methods, functions, steps, features, or anything related to the systems disclosed herein may be implemented by hardware, software (e.g., firmware), or circuits despite certain methods, functions, steps, or features having been described herein with reference to software corresponding thereto that is executable by a processor to achieve the desired method, function, or step. It is understood that software instructions may reside on a non-transitory medium such as one or more memories accessible to one or more processors in the systems disclosed herein. For example, where a computing device receives data, it is understood that the computing device processes that data whether processing the data is affirmatively stated or not. Processing the data may include storing the received data, analyzing the received data, and/or processing the data to achieve the desired result, function, method, or step. It is further understood that input data from one computing device or system may be considered output data from another computing device or system, and vice versa. It is yet further understood that any methods, functions, steps, features, results, or anything related to the systems disclosed herein may be represented by data that may be stored on one or more memories, processed by one or more computing devices, received by one or more computing devices, transmitted by one or more computing devices, and the like.

The foregoing description, for purposes of explanation, uses specific nomenclature and formula to provide a thorough understanding of the disclosed embodiments. It should be apparent to those of skill in the art that the specific details are not required in order to practice the disclosure. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the disclosure to the precise forms disclosed, and those of skill in the art recognize that many modifications and variations are possible in view of the above teachings.

The various embodiments described above can be combined to provide further embodiments. All of the U.S. patents. U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above described exemplary embodiments, but should be defined only in accordance with the following claims and their equivalents

1. A method for associating an authenticated autograph with physical memorabilia based on a blockchain, comprising:
recording a video that captures an identifiable person making a distinctive mark to be associated with a physical memorabilia;
causing the video to be cryptographically stored in the blockchain via a non-fungible token (NFT);
causing generation of a reference tag that encodes access to the NFT; and
causing physical affixing of the reference tag with the physical memorabilia.

2. The method according to claim 1, wherein the distinctive mark is a signature of the identifiable person.

3. The method according to claim 2, wherein the video captures the identifiable person creating the signature in contact with the physical memorabilia.

4. The method according to claim 1, wherein the video is cryptographically stored in the blockchain with a timestamp evidencing a temporal proximity to a conclusion of the recording.

5. The method according to claim 1, wherein the NFT is created with a timestamp evidencing a temporal proximity to a conclusion of the recording.

6. The method according to claim 1, wherein a reference to the video by the NFT is generated with a timestamp evidencing a temporal proximity to a conclusion of the recording.

7. The method according to claim 1, wherein the reference tag includes at least one of a quick response (QR) code or a radio-frequency identification (RFID) tag.

8. The method according to claim 1, wherein the causing of the video to be cryptographically stored in the blockchain via the non-fungible token (NFT) occurs in real-time with a conclusion of the recording of the video.

9. A method for associating an authenticated transformative event having a tangible result with a physical object based on a blockchain, comprising:
recording visual content that captures the transformative event having the tangible result to be associated with the physical object;
causing the visual content to be cryptographically stored in the blockchain via a non-fungible token (NFT);
causing generation of a reference tag that encodes access to the NFT; and
causing physical affixing of the reference tag with the physical object.

10. The method according to claim 9, wherein a distinctive mark is a signature of an identifiable person.

11. The method according to claim 10, wherein a video captures the identifiable person creating the signature in contact with a physical memorabilia.

12. The method according to claim 9, wherein a video is cryptographically stored in the blockchain with a timestamp evidencing a temporal proximity to a conclusion of the recording.

13. The method according to claim 9, wherein the NFT is created with a timestamp evidencing a temporal proximity to a conclusion of the recording.

14. The method according to claim 9, wherein a reference to a video by the NFT is generated with a timestamp evidencing a temporal proximity to a conclusion of the recording.

15. The method according to claim 9, wherein the reference tag includes at least one of a quick response (QR) code or radio-frequency identification (RFID) tag.

16. The method according to claim 9, wherein the causing of the visual content to be cryptographically stored in the blockchain via the non-fungible token (NFT) occurs in real time or near a conclusion of a capture of the visual content.

17. The method according to claim 9, wherein a captured video content of the transformative event having the tangible result includes one or more of a photo, a series of photos, another type of sensor image, and a series of sensor images from another type of sensor.

18. A system for associating an authenticated autograph with a physical memorabilia based on a blockchain, comprising:
a memory that stores computer-executable instructions; and
a processor that executes the computer-executable instructions that cause the processor to:
record a video that captures an identifiable person making a distinctive mark to be associated with the physical memorabilia;
cause the video to be cryptographically stored in the blockchain via a non-fungible token (NFT);
cause generation of a reference tag that encodes access to the NFT; and
cause physical affixing of the reference tag with the physical memorabilia.

19. A system for associating an authenticated transformative event having a tangible result with a physical object based on a blockchain, comprising:
a memory that stores computer-executable instructions; and
a processor that executes the computer-executable instructions that cause the processor to:
record visual content that captures the transformative event having the tangible result to be associated with the physical object;
cause the visual content to be cryptographically stored in the blockchain via a non-fungible token (NFT);
cause generation of a reference tag that encodes access to the NFT; and
cause physical affixing of the reference tag with the physical object.

20. The method according to claim 9, further comprising: linking the NFT with the physical object such that the NFT cannot be transferred without the physical object and the physical object cannot be transferred without the NFT.
